(19) United States
(12) Patent Application Publication
(10) Pub. No.: US 2010/0142315 A1
(43) Pub. Date: Jun. 10, 2010

(54) ASSESSMENT OF THE PERFORMANCE OF ULTRASOUND IMAGING SYSTEMS

(75) Inventors: Dariush Khadje Nassiri, London (GB); David Rowland, London (GB); Valentine Newey, London (GB)

Correspondence Address: STEPTOE & JOHNSON LLP, 2121 AVENUE OF THE STARS, SUITE 2800, LOS ANGELES, CA, 90067, US

(73) Assignee: ST GEORGE'S HEALTHCARE NHS TRUST, London (GB)

(21) Appl. No.: 12/525,669

(22) PCT Filed: Jan. 31, 2008
(86) PCT No.: PCT/GB2008/000310

§ 371 Date: Jan. 8, 2010

(30) Foreign Application Priority Data
Feb. 1, 2007 (GB) 0701963.1

(51) Int. Cl. H04B 17/00

(52) U.S. Cl. 367/13

(57) ABSTRACT

A phantom, and a method and system for scanning the phantom, is provided for assessing the performance of ultrasound scanners. The phantom has tissue mimicking material (TMM) sections with different backscatter properties. The resolution of the scanner is assessed by measuring the response of the system to a step change in backscatter. Penetration and sensitivity of the scanner can also be assessed by measuring backscatter properties. Layers of the phantom can comprise lesions to enable quantification of the lesion detection performance of the scanner. The scanner can also comprise regularly spaced targets to enable assessment of the distance measurement accuracy of the scanner.

This invention relates to a system and method for clinically relevant assessing of performance of ultrasound imaging systems, in particular, but not necessarily exclusively, ultrasound scanners.

### INTRODUCTION

The assessment of the performance of medical ultrasound imaging systems, such as ultrasound scanners, is currently conducted using phantoms some of which attempt to mimic the ultrasound properties of human tissue. A range of assessment parameters are used. Parameters recommended in the IPEM handbook¹ include: resolution in the x,y,z dimensions, generally referred to as axial and lateral resolution and slice thickness respectively; cyst detection; high and low contrast resolution; penetration; accuracy of distance measurement in the x,y dimensions. Several techniques have been reported^{2,3,4,5} for resolution assessment and a popular method consists of a phantom containing thin wire or filament targets embedded at regular intervals within tissue mimicking material (TMM). The targets are imaged and the scanner point spread function is defined by manually delineating the targets, which appear as bright ellipsoids against the background backscatter, using the scanner cursors. Cyst detection is assessed using phantoms typically consisting of patterns of hypo echoic cylindrical or spherical voids of specific size, typically 1 to 4 mm diameter, embedded in TMM. The cysts are imaged and the results manually assessed.

Disadvantages of the reported resolution assessment methods include:
1. Some measurements are not continuous as targets are generally arranged at discrete intervals.
2. Visualization of the targets requires the scanner gain settings to be at levels that are not clinically relevant.
3. Frequency dependence of most targets does not match human tissue resulting in overestimation of scanner performance.
4. Most current methods require significant manual intervention making measurements subjective, time consuming and costly.
5. Systematic limitations such as target alignment, or caliper size or quantization error influence results.
6. Assessment in any given dimension may not be independent of other dimensions.

Problems with cyst assessment methods include:
1. Manual assessment is subjective.
2. Difficulty in differentiating small cysts from speckles.
3. Difficulty in aligning the image plane normal to the cyst centers.
4. Difficulty in automating assessment due to translation and scaling changes within the x,y plane, rotation about the x,y or z axes, and partial imaging of cyst patterns with depth etc. resulting in 8 or more degrees of freedom.

Problems with automating assessment of scanner distance measurement:
1. Different scanner manufacturers use different fonts, text size and formats to represent distance information e.g. 3.5 mm, 0.35 cm
2. The x,y location within images at which distance information is presented is manufacturer dependent.

Ideally an assessment system should allow testing of linear, curved and phased array scanner probes with clinically relevant scanner settings at reasonable levels of backscattering, attenuation and frequency dependence, and with invariance to other factors discussed.

According to a first aspect, the present invention provides a method of assessing the resolution of an ultrasound scanner comprising the step of monitoring the response of the system to a step change in backscatter.

Preferably the method is fully automated.

Preferably the resolution in the x,y and/or z dimensions of the system are assessed. The step change in backscatter may cause a sudden change in input signal strength to the system.

In an imaging system, the gradient of the step response function (SRF) is the impulse response (IR)^{6,7}. This means that if the SRF is known then the IR can be calculated and from that an appropriate resolution parameter, for example the full width half maximum (FWHM).

Preferably, the method comprises the steps of determining the step response function (SRF) of the scanner, determining the gradient of the step response function to obtain the impulse response (IR) and calculating, from the IR, the full width half maximum (FWHM).

In order to generate a step input to the ultrasound scanner under test there may be provided a phantom with two different TMM blocks which can be traversed by an ultrasound probe of the scanner, there being a sufficient difference in backscatter properties between the blocks to generate a step signal.

Preferably, the TMM blocks are agar based with their recipe respectively adjusted to give the required difference in backscatter properties.

According to a second aspect, the present invention provides a phantom comprising two TMM blocks with different backscatter properties, as described above with respect to the first aspect of the present invention.

According to a third aspect, the present invention provides a method of assessing the penetration and/or sensitivity of an ultrasound scanner, the method comprising the steps of scanning a phantom comprising two sections with different backscatter properties, and determining the depth at which the scanner determines the backscatter from the two sections to be equal.

The phantom used in the third aspect may be a phantom as described above with respect to the first and second aspect of the present invention.

According to a fourth aspect of the invention, there is provided a method for quantifying lesion detection performance of an ultrasound scanner, comprising the steps of scanning a phantom comprising a reference layer of reference lesions and one or more other layers of lesions to obtain an image set for each layer, detecting the pattern and position of the reference lesions and detecting the positions of the lesions of the other layers.

The lesions may be cysts, e.g. anechoic cysts.

Preferably, the method is fully automated. The method steps may be carried out by a computer.

Preferably, the reference lesions are larger than the lesions of the other layers. Preferably, the reference lesions are 4 mm in diameter or larger. Having large reference lesions permits a wide range of scanner resolutions to be used. The lesions of the other layers may be 1 mm or 2 mm in diameter, for example.

Preferably, the step of detecting the pattern of the lesions of the reference layer comprises the steps of: combining images of the reference layer into a composite image to compensate for misalignment of a probe of the ultrasound scanner; generating a reference pattern mask corresponding to an ideal scanned image, and adjusting the translation, scaling and/or rotation of the reference pattern mask and/or the composite reference image so that mask and the composite image match, the positions of the lesions in the reference layers being determined by extracting the positions of the individual lesions from the matched reference pattern mask. Preferably, for each lesion, the precise position is determined by searching through the images of the reference layer to find the image that best represents the lesion.

Preferably, once the locations of the reference lesions have been determined, the positioning of the lesions of the other layers are directly related to the positions of the reference lesions. Preferably, for each lesions of the other layers, the precise position is determined by searching through the images of the lesion to find the image that best represents the lesion.

Preferably, a detection confidence value c is determined for each lesion.

According to a fifth aspect, the present invention provides a phantom comprising a reference layer of lesions and one or more other layers of lesions, as described above with respect to the fourth aspect of the invention.

According to a sixth aspect, the present invention provides a method of assessing the distance measurement accuracy of an ultrasound scanner, the method comprising the steps of: scanning a phantom comprising a TMM section containing a plurality of targets spaced at regular reference intervals to produce an image on a display, positioning two or more cursors on the display separated by predetermined distances, and detecting the positions of the reference targets and the cursors and calculating a distance measurement error.

Preferably, the scanner gain is reduced to zero to give a black image background on the display prior to the positing of the cursors.

According to a seventh aspect, the present invention provides a phantom comprising a plurality of targets spaced at regular reference intervals as described above with respect to the sixth aspect of the present invention.

According to an eighth aspect, the present invention provides a phantom according to two or more of the second, fifth, and seventh aspects of the invention, such that phantom can be used to assess a plurality of parameters of an ultrasound scanner.

Preferably, in order to minimize set-up time in repeat studies using the above described methods, relevant information such as scanner spatial calibration, region of interest used for analysis and/or scanner gain uniformity versus depth can be saved in a data file and recovered for immediate use as reference or to avoid repeat operations.

Embodiments of the present invention will now be described by way of example only, with reference to the accompanying drawings, in which:

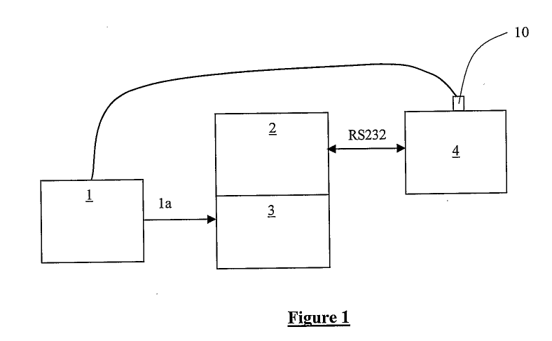

FIG. 1 shows a schematic diagram of the system components according to an embodiment of the present invention. Images from a scanner 1 under test are captured with a frame grabber 3 using a scanner video output 1a. A phantom 4 and frame grabber 3 are controlled by a personal computer (PC) 2.

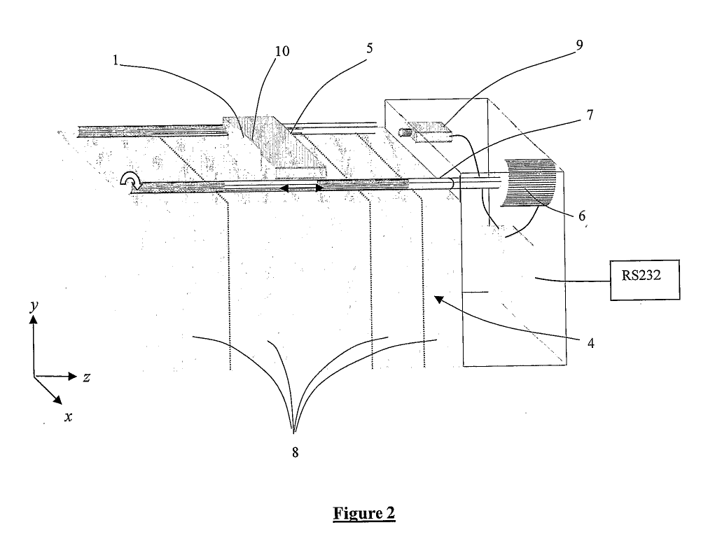

FIG. 2 shows the design of a phantom according to an embodiment of the present invention, used in the system of FIG. 1. The ultrasound probe 10 is attached to a probe platform 5 and the platform 5 is driven in the z direction by a motor/gearbox 6 controlled lead screw 7 or other mechanism. A ‘home’ position micro switch 9 acts as a start reference. The position of each section 8 along the z axis in the phantom 4 is known. Images in the x,y plane are collected at discrete intervals along the z axis under computer control. Each section 8 of the phantom contains test objects specific to a give performance test e.g. x,y,z resolution, cyst detection, contrast, penetration.

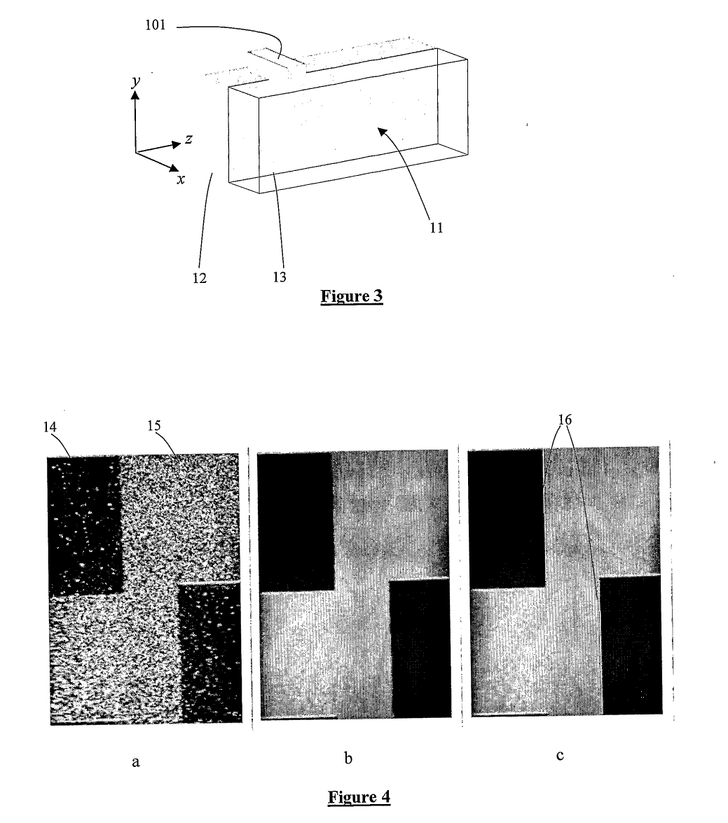

FIG. 3 shows a lateral resolution phantom 11 according to an embodiment of the present invention with high and low backscatter sections 12, 13. The probe 14 is moved in the z direction to produce x,y plane images containing a step change in backscatter in the x direction.

FIG. 4 shows example images of backscatter steps in x and y directions. Low backscatter regions 14 and high backscatter regions 15 are shown. In FIG. 4, a: single image, b: addition of multiple images, c: detected lateral resolution edges (cursors 16).

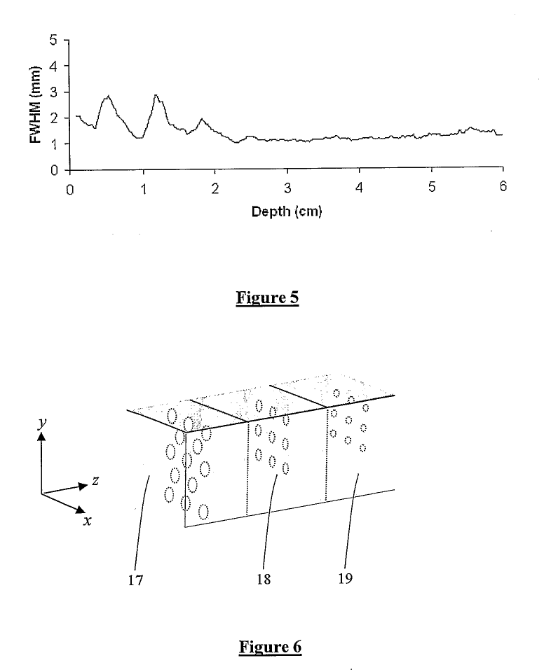

FIG. 5 shows example lateral resolution data generated by the method, in particular, lateral resolution (FWHM) versus penetration depth for a Toshiba SSA-340A scanner with 7 MHz C70 probe and focus set at 4 cm. The prominent disturbances at approximately 0.5 cm, 1.5 cm and 1.9 cm depth are due to real focal zone banding artifacts.

FIG. 6 shows a typical arrangement of cyst sections in a phantom according to an embodiment of the present invention.

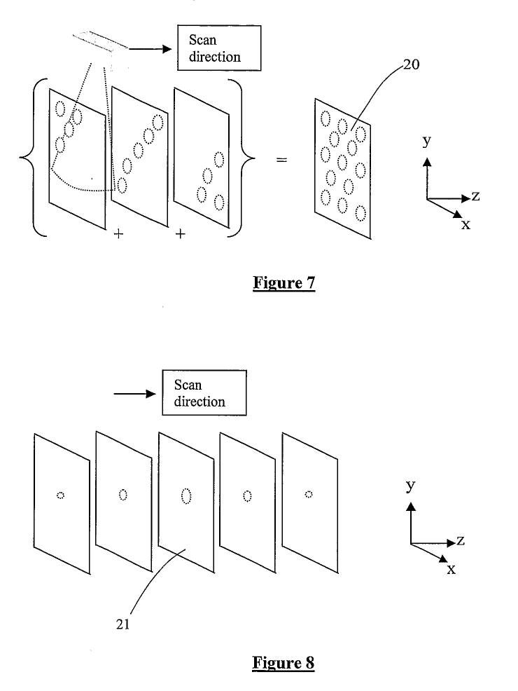

FIG. 7 shows a cyst detection image process that compensates for probe misalignment. If the probe is misaligned such that only parts of the reference layer are imaged by each frame then adding image frames results in a composite image i_{c}20 which compensates for probe misalignment.

FIG. 8 shows examples of images acquired through a single cyst, with a center image 21 that best represents the cyst.

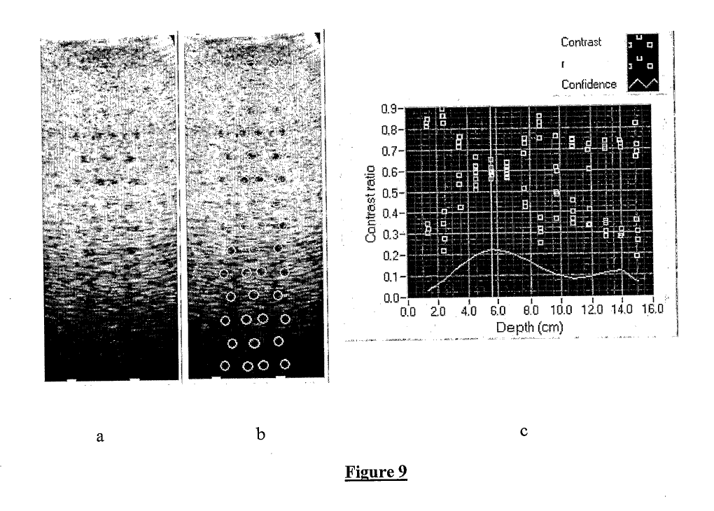

FIG. 9 shows cyst detection data generated by the method according to an embodiment of the invention. In FIG. 9: a: shows one frame from the set iᵣ, b: shows position of translation, scale and rotation adjusted cyst pattern mask, c: shows a graph of contrast, correlation r and confidence c (polyfit).

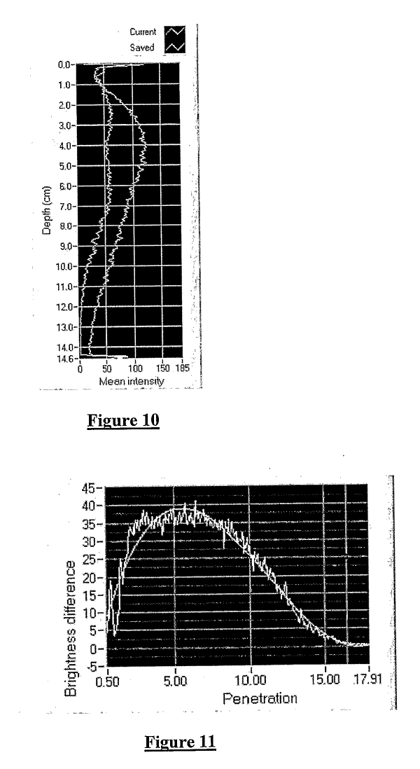

FIG. 10 shows data generated by the scanner brightness uniformity method. Information is saved as a ‘Setup’ file. This enables the operator to adjust the gain and TGC of a scanner to match values saved during an earlier study. ‘Saved’ data shows scanner gain optimised for similar brightness down to 7 cm (limit of penetration for the scanner) to which ‘Current’ data would be adjusted for a repeat study.

FIG. 11 shows an example of penetration depth estimation data. It is shown as the ratio of backscatter brightness on either side of a TMM step as a function of depth. Data is smoothed with a polynomial function and the point at with the ratio is equal to one is the penetration depth.

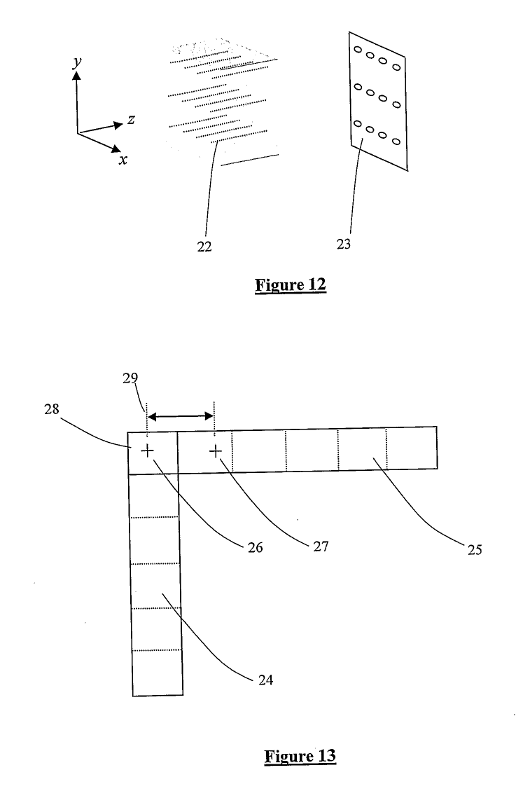

FIG. 12 shows an example distance measurement phantom section according to an embodiment of the present invention.

FIG. 13 shows an example of the distance measurement method PC overlay according to an embodiment of the present invention. Vertical measurement cells 24 and horizontal measurement cells 25 are provided at defined intervals, e.g. 1 cm.

According to a first embodiment, the analysis system, for testing an ultrasound scanner 1, as shown in FIG. 1 and FIG. 2, consists of two main components; a personal computer (PC) 2 containing a frame grabber 3 or other image capture device for image acquisition, and control and analysis software; a phantom 4 consisting of an ultrasound probe holder or probe platform 5 driven in the z direction by a computer controlled motor or motor/gearbox 6 and lead screw 7, and several sections of TMM 8 each designed to address specific scanner performance parameters. The z axis position of the probe holder 5 and the location of each phantom section 8 in relation to the ‘home’ microswitch 9 are known to the system and images acquired when scanning the sections are processed by the PC analysis software. In use an operator would: attach an ultrasound probe 10 to the probe holder 5 and adjust the probe 10 to correctly align in the x,y,z planes; acquire an image and spatially calibrate the system (this may change with scanner zoom setting etc); adjust the scanner gain and time gain control to give uniform image brightness with depth; move the probe holder 5 to a reference position on the z axis from which the system can calculate the probe geometrical thickness and thus the correct position of phantom sections 8 relative to the probe image plane; select a region of interest within the image for analysis; place the scanner distance measurement cursors at two or more positions in the scanner image at defined separations; save reference data e.g. scanner and probe information, spatial calibration and probe geometrical thickness etc in a ‘setup’ file for subsequent recall so that for a repeat test on a given scanner/probe combination only the probe attachment, alignment, gain adjustment and distance measurement stages would be required; start the automated data collection and analysis; view results.

### Resolution Assessment Method

Problems identified in the introduction were addressed by assessing resolution in the x,y or z dimensions using the scanner systems step response i.e. response to a sudden change in input signal strength. In an imaging system, the gradient of the step response function (SRF) is the impulse response (IR)^{8,9}. This means that if the SRF is known then the IR can be calculated and from that the full width half maximum (FWHM).

In order to generate a step input to the ultrasound scanner under test it a phantom is provided with two different TMM blocks which can be traversed by the ultrasound probe, with a sufficient difference in backscatter between blocks to generate a step signal.

### Resolution Phantom Design Example

FIG. 3 shows an embodiment of a phantom 11 having one possible arrangement of TMM blocks to measure lateral resolution (x dimension). The phantom 11 has a high backscatter section 12 and a low backscatter section 13. Speckle noise is reduced by taking multiple images at appropriate intervals with the scanner probe moving in the z-direction such that the position of the lateral resolution TMM step is at the same location in the x,y plane in each image. The images are combined (added) in the z direction to reduce speckle noise giving one image from which the profile of the step can be determined. Images are captured using a computer controlled motorized system that moves the scanner probe 101 along the z dimension, with data analyzed by computer. Many TMM material combinations are suitable, for example an agar based TMM¹⁰ with the recipe adjusted to give the required difference in backscatter on either side of the step.

### Resolution Image Analysis Example

The analysis software can have several stages to identify and quantify the step response. Many different sequences are possible and the following is an example for lateral resolution with example results in FIG. 4 and FIG. 5.
1. Scan the phantom in the z direction, obtaining a set iₙ of images at regular sample intervals. An example of an image in this set is shown in FIG. 4a.
2. Apply an algorithm over the set iₙ to reduce speckle noise, for example adding images, which in this case produces a single image i₀ (FIG. 4b).
3. Vertical averaging (y direction) of i₀ with a suitable averaging function may be required.
4. Detect the step edge in i₀ (FIG. 4c).
5. find the inverse function that best describes the step profile, for example inverse(sinc)²
6. calculate the FWHM or other appropriate metric for the inverse function

Similar methods can be used to obtain resolution in other dimensions such as axial resolution or slice thickness by appropriate positioning of a step in the phantom and adjustment to the processing algorithm.

### Lesion Cyst Detection Method

### (The Example Shown Here is for Cyst Lesions)

With reference to FIG. 6 and FIG. 7 the phantom cyst section consists of a reference pattern layer 17 of relatively large hypo echoic cysts (to cover a wide range of medical scanner resolutions) of a specific pattern, and one or more layers 18, 19 of smaller sized cysts (e.g. 2 mm cyst pattern layer 18 and 1 mm cyst pattern later 19) arranged such that all cysts within a given layer can be imaged simultaneously in the same x,y plane. The reference and smaller cysts can also be organized or combined in other arrangements of layers or patterns. Detection of cysts is based on three phases; scanning the phantom sections in the z direction and obtaining x,y plane images at regular sampling intervals to give image sets for each cyst size; detection of the cyst reference pattern; detection of smaller cysts e.g 1 and 2 mm cysts. The reference pattern detection phase consists of several stages; combining reference images into a composite image 20 to compensate for probe misalignment; generation of a reference pattern mask corresponding to an ideal scanned image (normalized translation, scaling and rotation); adjusting the translation, scaling and rotation of either the reference pattern mask or composite reference image (in this case the reference pattern) so that the two images match; extracting positions of individual cysts from the matched reference pattern mask; for each cyst position a search through the reference images to find the image that best represents the cyst. Once the locations of reference cysts have been detected in the x,y plane the 1 and 2 mm cysts can be directly related to the reference cyst positions, necessitating only a search for each cyst through the appropriate image set to find the image which best represents the cyst. The sequence is shown in greater detail below:
1. Construct a pattern of reference cysts of relatively large size e.g. 4 mm diameter, in a single layer at known x,y spatial positions within the layer.
2. Construct additional layers containing smaller cysts e.g. 1 or 2 mm diameter for which the x,y spatial coordinates relative to the reference pattern are known. These layer can be combined into one layer if appropriate spacing on the x,y plane exits between cysts.
3. Image the reference cysts at regular intervals along the z axis e.g. 0.1 mm (FIG. 6 and FIG. 7) giving a reference image set
4. Image the minor cysts at regular intervals along the z axis as above giving image sets iₘ₁ ^{and i}ₘ₂.
5. Add images in the reference set 4. (FIG. 7) to obtain a composite reference image i_{c} 20.
6. Conduct a search to find a best match using for example cross correlation between the composite image i_{c} and a pattern mask pₘ of cysts in their expected positions. This requires a search with continuous adjustment of translation, scaling and rotation of pₘ to find the highest correlation between pₘ and composite image i_{c}. On search completion calculate the coordinates of the centers of each of the reference cysts from the translation, scale and rotation adjusted pₘ. Record the x,y location l_{xy} of each cyst in pₘ.
7. Generate a mask in equivalent to a single reference cyst.
8. For each cyst cᵢ in pₘ search through the image set iᵣ (FIG. 8) at the location l_{xy} for the image with greatest cross correlation r between m and an area in iᵣ centered on l_{xy} of the same size as m. The image with highest correlation i_{r′} will have its x,y plane passing through the centre of the cyst cᵢ (center image 21 in FIG. 8).
9. For cyst cᵢ in image i_{r′} calculate the cyst contrast i.e. the ratio of average image intensity inside the cyst to average image intensity bordering the cyst. Calculate a confidence value c for the cyst:

c=(1−(k1/k2))/r
where k1=mean intensity inside cyst
   k2=mean intensity outside cyst
and 0<=c<=1
10. Repeat steps 7 to 9 for the minor cyst image sets iₘ₁ and iₘ₂.

An example of data generated by the method is shown in FIG. 9.

### Penetration Assessment Method

The change in contrast with depth on either side of the step (FIG. 3 and FIG. 11) can be used for penetration/sensitivity assessment, with penetration defined as the depth at which received signal from both sections becomes equal.

### Contrast Assessment Method

High and low contrast discrimination can be assessed using relatively large cysts e.g. 10 mm diameter with a defined backscatter level using a similar cyst detection method as previously outlined.

### Distance Measurement Assessment Method

Ultrasound scanner can be used to measure anatomical features within images e.g. cranial diameter. It is essential therefore to assess the accuracy of measurements. This requires a phantom containing features of known reference dimensions or separations, and in order to automate the assessment some method of correlating scanner distance measurements with the known phantom reference distances.

The method described here requires three phases:
1. Scanning of a phantom TMM section that contains a series of targets spaced at regular reference intervals e.g. thin wire filaments 22 at 1 cm giving ellipsoidal shaped targets in the x,y plane image 23 (FIG. 12).
2. The operator reduces scanner gain to zero giving a black image background and positions two or more scanner measurement cursors 26, 27 so that they appear at specific positions in overlays on the PC display (FIG. 13) separated by precisely defined distances 29 e.g. 1.00 cm, 2.00 cm on the scanner display.
3. The PC system detects reference targets from phase 1 and the 1^{st} and 2^{nd} cursors 26, 27 in phase 2 and calculates differences in positions to give distance measurement error. The target positions are at known x,y plane locations relative to the cyst positions defined in the cyst detection method above. Scanner cursor positions can be detected by for example cross correlating the reference cell 28 with each horizontal or vertical measurement cells 24, 25.

### Methods To Minimize Operator Intervention

In order to minimize set-up time in repeat studies relevant information such as scanner spatial calibration, region of interest used for analysis and scanner gain uniformity versus depth can be saved as ‘Setup’ data and recovered for immediate use as reference or to avoid repeat operations. An example of scanner gain uniformity data is shown in FIG. 10.

### REFERENCES

¹ Report 71: Routine Quality Assurance of Ultrasound Imaging Systems. IPEM 1995 ISBN: 0 904181 82 0
² Skolnick M L (1991). Estimation of ultrasound beam width in the elevation (slice thickness) plane. Radiology 180 286-288
³ MHRA {formerly MDA} (1998). Report number MDA/98/52 (Further revisions to guidance notes for ultrasound examination of the breast, with protocol for quality testing). HMSO
⁴ Nicholas M. Gibsona, Nicholas J. Dudleya and Kate Griffitha (2001). A computerised quality control testing system for B-mode ultrasound. Ultrasound in Medicine & Biology 27, 1697-1711.
⁵ S D Pye, W Ellis and T MacGillivray (2004). Medical ultrasound: a new metric of performance for greyscale imaging. Journal of Physics: Conference Series 1 187-192
⁶ Abhishek Singh, Chintan Patel and Jim Plusquellic, ‘On-Chip Impulse Response Generation for Analog and Mixed-Signal Testing’ IEEE International Test Conference 2004; 262-270
⁷ Koichi Kanaya, Eisaku Oho, Michiaki Naka, Takehiko Koyanagi, And Toshihide Sasaki. ‘An Image Processing Method for Scanning Electron Microscopy Based on the Information Transmission Theory’ Journal Of Electron Microscopy Technique 1985; 2:73-87
⁸ Abhishek Singh, Chintan Patel and Jim Plusquellic, ‘On-Chip Impulse Response Generation for Analog and Mixed-Signal Testing’ IEEE International Test Conference 2004; 262-270
⁹ Koichi Kanaya, Eisaku Oho, Michiaki Naka, Takehiko Koyanagi, And Toshihide Sasaki. ‘An Image Processing Method for Scanning Electron Microscopy Based on the Information Transmission Theory’ Journal Of Electron Microscopy Technique 1985; 2:73-87
¹⁰ Teirlinck C., Bezemer R., Kollmann et al ‘Development of an example flow test object and comparison of five of these test objects, constructed in various laboratories’ Ultrasonics 1998; 36: 653-660.

1. A method of assessing the resolution of an ultrasound scanner comprising:
monitoring the response of the system to a step change in backscatter;
determining the step response function (SRF) of the scanner;
determining the gradient of the step response function to obtain the impulse response; and
calculating a resolution parameter from the impulse response.

2. (canceled)

3. The method of claim 2, wherein the resolution parameter is the full width half maximum (FWHM).

4. The method of claim 1, wherein the scanner scans a phantom having sections with different backscatter properties.

5. A method of assessing the penetration and/or sensitivity of an ultrasound scanner, the method comprising:
scanning a phantom comprising two sections with different backscatter properties; and
measuring the depth at which the scanner determines the backscatter from the two sections to be equal.

6. A phantom for use in the method of claim 5, the phantom comprising two TMM blocks with different backscatter properties.

7. The method of claim 1, wherein the method is automated.

8. A method for quantifying the lesion detection performance of an ultrasound scanner, the method comprising:
scanning a phantom comprising a reference layer of reference lesions and one or more other layers of lesions to obtain an image set for each layer;
detecting the pattern and position of the reference lesions; and
detecting the positions of the lesions of the other layers.

9. The method of claim 8, wherein the detecting the pattern of the lesions in the reference layer comprises:
combining images of the reference layer into a composite image to compensate for misalignment of a probe of the ultrasound scanner;
generating a reference pattern mask corresponding to an ideal scanned image; and
adjusting the translation, scaling or rotation of the reference pattern mask or the composite image so that the mask and the composite image match, the positions of the lesions in the reference layers being determined by extracting the positions of the individual lesions from the matched reference pattern mask.

10. The method of claim 9, wherein, for each lesion, a precise position is determined by searching through images of the reference layer to find the an image that best represents the lesion.

11. The method of claim 10, wherein, once locations of the referenced lesions have been determined, the positioning of lesions of the other layers are directly related to the positions of the referenced lesions.

12. The method of claim 11, wherein the precise position of the lesions of the other layers are determined by searching through the images of the lesion to find the image that best represents the lesion.

13. A phantom for use in the method of claim 8, the phantom comprising a reference layer of lesions and one or more other layers of lesions.

14. The method of claim 8, wherein the method is automated.

15. The method of claim 8, wherein the lesions are cysts.

16. A method of assessing the distance measurement accuracy of an ultrasound scanner, the method comprising:
scanning a phantom comprising a TMM section containing a plurality of targets spaced at regular reference intervals to produce an image on a display;
positioning two or more cursors on the display separated by predetermined distances;
detecting the reference targets and the cursors, and
calculating a distance measurement error.

17. A phantom for use in the method of claim 16, the phantom comprising a plurality of targets spaced at regular reference intervals.

18. The method of claim 16, wherein the method is automated.

19. The method of claim 1, wherein the method assesses ultrasound beam resolution of an ultrasound scanner in x, y or z dimensions by using a step change in backscatter to quantify image point spread function.

20. The method of claim 1, wherein the method automatically quantifies cyst detection performance of an ultrasound scanner.

21. The method of claim 1, wherein the method automatically scans a phantom, collects image data, and processing results.

22. The method of claim 1, wherein the method saves settings for a given scanner in a setup file, wherein the settings include image x, y, z spatial calibration, region of interest used for analysis, probe type, and combinations thereof, and wherein the setting are loaded in subsequent tests to minimize repetition of setup and calibration procedures.

23. The method of claim 22, wherein the method calculates and equalizes image brightness as a function of depth, and wherein the resulting equalization function can be saved with setup data and scanner gain settings can be quickly equalized in subsequent tests after loading the equalization function from a setup file.

24. The method of claim 1, wherein the method calculates high and low contrast resolution.

25. The method of claim 5, wherein the method calculates penetration based on a ratio of backscatter brightness on either side of a TMM step.

26. The method of claim 1, wherein the method calculates scanner measurement distance accuracy.
